(19) United States
(12) Patent Application Publication
(10) Pub. No.: US 2021/0244978 A1
(43) Pub. Date: Aug. 12, 2021

(54) LOW PRESSURE MISTING NOZZLE AIRCRAFT FIRE PROTECTION SYSTEM

(71) Applicant: Kidde Technologies, Inc., Wilson, NC (US)

(72) Inventors: Paul Papas, West Hartford, CT (US); Adam Chattaway, Windsor (GB); Terry Simpson, Wake Forest, NC (US)

(21) Appl. No.: 16/787,836

(22) Filed: Feb. 11, 2020

(51) Int. Cl. A62C 3/00; A62C 3/08; A62C 99/00

(52) U.S. Cl. CPC A62C 3/002; A62C 99/0072; A62C 99/0018; A62C 3/08

(57) ABSTRACT

A system for fire suppression having a fuel tank inerting system configured to produce an inert gas mixture, a water source, and a low pressure misting nozzle directed into a cargo hold. The low pressure misting nozzle is configured to produce a mist solution using the inert gas mixture and water.

### BACKGROUND

The present disclosure relates generally to fire suppression in an aircraft cargo hold. More specifically, the disclosure relates to a green fire suppression system in an aircraft cargo hold that does not require Halon 1301.

Currently, all US airlines are required to have engine inerting systems, which decrease the oxygen level in the fuel tanks to below the concentration required for ignition. The primary system currently in use utilizes a fiber membrane material that separates supplied air into nitrogen-enriched air and oxygen-enriched air.

The FAA also requires that all cargo holds have a fire detection and suppression system. Current fire suppression systems utilize a high-rate discharge bottle of hydrofluorocarbon (HFC) to knock down the fire, then a low-rate metered discharge bottle of HFC designed to keep the fire suppressed until the plane can safely land.

With the ban of Halon 1301 for aircraft use, the aerospace industry is facing difficulties in identifying HFC alternatives that satisfy the FAA requirements for fire suppression. Other industries, such as HVAC, are already facing regulations to use low Global Warming Potential (GWP) materials, and some countries such as Switzerland have pushed to ban the use of HFCs altogether. With the ongoing focus on global climate change issues, the development of green fire suppression systems is additionally desirable.

### SUMMARY

A system for fire suppression includes a fuel tank inerting system configured to produce an inert gas mixture, a water source, and a low pressure misting nozzle directed into a cargo hold. The low pressure misting nozzle being configured to produce a mist solution using the inert gas mixture and water.

### BRIEF DESCRIPTION OF THE DRAWINGS

FIG. 1 is a flow chart of a representative method for fire suppression using a fuel tank inerting system.

FIG. 2 is a process flow diagram of a representative method for fire suppression using a fuel tank inerting system.

FIG. 3 is a process flow diagram of a method for fire suppression using a membrane fuel tank inerting system.

FIG. 4 is a process flow diagram of a method for fire suppression using a catalytic fuel tank inerting system.

FIG. 5 is a process flow diagram of a method for fire suppression using a electrochemical fuel tank inerting system.

FIG. 6 is a process flow diagram of a representative embodiment of the method of FIG. 5.

### DETAILED DESCRIPTION

Fire suppression systems are required in the cargo holds of all US airlines. Because current fires suppression systems utilize HFCs, and HFCs will be banned in the future, new fire suppression systems are required. The FAA requires that these new systems be at least as good as current systems at fire knock down and suppression.

Gas only fire suppression systems require that the flow rate of the gas, typically nitrogen, be high in order to effectively knock down a fire. Therefore, many designs require pressurized gas tanks to obtain the high flow rates. Pressurized gas tanks are large and heavy, and therefore, a lighter and more space efficient method of environmentally friend fire suppression is desired. Aircraft currently have a fuel inerting system, which reduces the oxygen level in the fuel tank to a level below that required for ignition of the fuel. Utilizing the fuel inerting system already present on the aircraft to provide the gas for the fire suppression system would remove the need for pressurized gas tanks, however it is difficult to obtain the high flow rates required in the knock down stage of the fire suppression.

As described herein, in order to utilize the inerting system to provide the gas mixture and still be effective at a low flow rate, water mist is additionally utilized in the fire knock down stage. Specifically, the inerting gas mixture is diverted to a low pressure water mist nozzle to form a water mist. In some embodiments, the inerting gas mixture can be supplemented or replaced by a hydrofluorocarbon. The combination water mist/inerting gas mixture is then pumped into the cargo hold to complete the fire knock down stage. After the fire has been knocked down, inerting gas mixture can be flowed into the cargo hold at a relatively low flow rate to maintain a low oxygen environment or specific agent concentration level during the fire suppression stage. The system described herein effectively knocks down and suppresses fires at a lower total agent amount compared to bottled nitrogen fire suppression systems, allowing for the utilization of gas from the fuel inerting system. As a result, pressurized gas tanks are not necessary, reducing the weight and environmental impact of the fire suppression system.

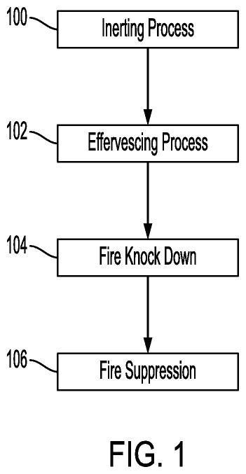

FIG. 1 is a flow chart of a representative method for fire suppression using a fuel tank inerting system. FIG. 1 shows that inerting process 100 is performed, followed by an effervescent nozzle process 102, fire knock down 104, and fire suppression 106.

Inerting process 100 is performed in the fuel tank. The inerting process can be a selective membrane, catalytic, or electrochemical process. A selective membrane process uses a membrane which selectively allows nitrogen through to reduce the oxygen level of the gas mixture in the fuel tank below 12%. In some embodiments, for example, the oxygen level is below 10%, below 9% or below 7%. In a catalytic inerting system, the system reacts on-board jet fuel to make a gas mixture of carbon dioxide, nitrogen, and water. The generated gas mixture reduces the oxygen level of the gas mixture in the fuel tank below 12%. In some embodiments, for example, the oxygen level is below 10%, below 9% or below 7%. In an electrochemical process with water and air, an electrochemical potential is used to separate oxygen from the air. The generated gas mixture reduces the oxygen level of the gas mixture in the fuel tank below 12%. In some embodiments, for example, the oxygen level is below 10%, below 9% or below 7%. In embodiments where water is produced in the inerting process, the water must be removed from fuel tank inerting in order to prevent fuel fouling issues. The water can be stored in condensation tanks. The stored water can then be utilized in fire suppression or other non-potable usages (e.g. sanitation).

Effervescing process 102 creates water mist using the water, the inert gas mixture, and/or hydrofluorocarbon. The fuel tank is functionally connected to an effervescent system such that the inerting gas mixture can be transferred between them. In the effervescent system, the inerting gas mixture is bubbled through water inside the injection nozzle at a low pressure. Water can be sourced from a condensation tank or from the onboard water stores (e.g. for cooking, sanitation, drinking, etc.). Low pressure can be less than 4 atm, less than 3 atm or less than 2 atm. The low pressure effervescent system produces a water mist which is delivered to the cargo hold. The water mist has a droplet size, for example, of no greater than 1000 microns, no greater than 500 microns, or no greater than 100 microns.

In fire knock down stage 104, the water mist can be delivered through a low pressure nozzle driven by the inerting gas. The flow rate of the water mist and inerting gas can be, for example, between 200 cubic feet per minute and 40 cubic feet per minute, or between 150 cubic feet per minute and 50 cubic feet per minute. Additional inerting gas can be provided through additional low pressure nozzles without water mist. The flow rate of the inerting gas can be, for example, between 200 cubic feet per minute and 40 cubic feet per minute, or between 150 cubic feet per minute and 50 cubic feet per minute. The fire knock down stage continues until the fire is suppressed or reduced to acceptable level. The water mist coupled with the inerting gas effectively knocks down fires by directly cooling the fire with water and dilution, thereby reducing the fire temperature through physical heat absorption and water vaporization, and by inhibiting the fire by displacing the oxygen rich atmosphere with an oxygen poor inerting gas environment.

After the fire is knocked down, fire suppression stage 106 controls any remaining fire and prevents any new fires until the plane can safely land. In the fire suppression stage, inerting gas is pumped into the cargo hold at a relatively low rate to maintain agent concentration and overcome leakage from the cargo hold. The addition of inerting gas may be continuous or intermittent. The flow rate of the inerting gas can be, for example, between 200 cubic feet per minute and 40 cubic feet per minute, or between 150 cubic feet per minute and 50 cubic feet per minute. The inerting gas in the fire suppression stage can be provided through the low pressure water mist nozzles and/or through inerting gas specific nozzles. The inerting gas flow reduces the oxygen level of the gas mixture in the cargo hold below 16%. In some embodiments, for example, the oxygen level is below 12%, below 9% or below 7%. The fire suppression step can continue as long as is required to land safely. The oxygen level or agent concentration level can be monitored continuously or intermittently to ensure the oxygen or agent level of the gas mixture is in the target design range.

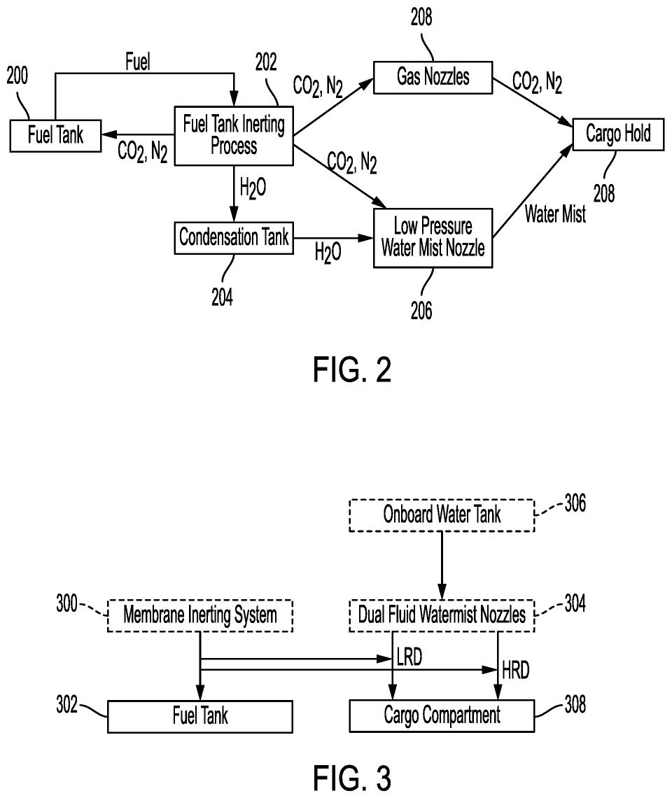

FIG. 2 is a process flow diagram of a representative method for fire suppression using a fuel tank inerting system. FIG. 2 shows fuel tank 200, fuel tank inerting system 202, condensation tank/water source 204, low pressure water mist nozzle 206, gas nozzles 208 and cargo hold 208. Fuel tank 200 contains jet fuel which, by fuel tank inerting process 202, is converted into carbon dioxide, nitrogen, and water. The water is diverted into condensation tank/water source 204, where it is held until required. When fire suppression is required the carbon dioxide and nitrogen (inerting gas) is flowed through gas nozzles and/or low pressure water mist nozzle 206 into cargo hold 208. The water is flowed from condensation tank/water source 204 into low pressure water mist nozzle 206. The water and inerting gas forms a water mist that is flowed into cargo hold 208.

FIG. 3 is a process flow diagram of a method for fire suppression using a membrane fuel tank inerting system. FIG. 3 shows that membrane inerting system 300 provides inerting gas to fuel tank 302 and dual fluid water mist nozzles 304. Onboard water tank/water source 306 provides water to dual fluid water mist nozzles 304. Dual fluid water mist nozzles form a water mist from the inerting gas and the water and delivers the mist into cargo compartment 308 at either a low rate of discharge (LRD) or a high rate of discharge (HRD).

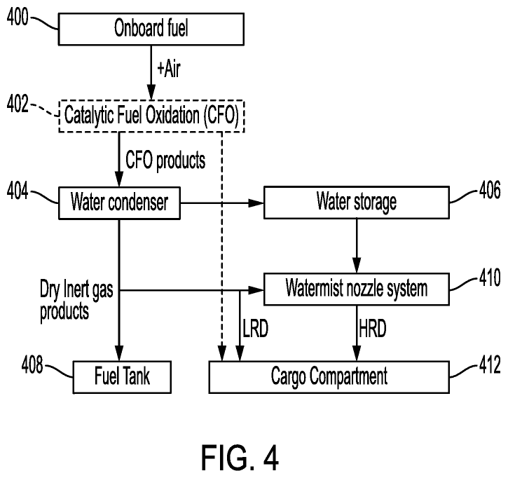

FIG. 4 is a process flow diagram of a method for fire suppression using a catalytic fuel tank inerting system. FIG. 4 shows that onboard fuel 400 is provided to catalytic fuel oxidation system (CFO) 402. CFO 402 produces water and inerting gas. The CFO products are passed through water condenser 404, which removes the water from the CFO products and store it in water storage/water source 406. The dry inert gas products are then provided to fuel tank 408. If required for fire suppression, dry or humid inert gas can be diverted to water mist nozzle system 410. Water storage/water source 406 provides water to dual fluid water mist nozzles system 410. Dual fluid water mist nozzles form a water mist from the inerting gas and the water and delivers the mist into cargo compartment 412 at either a low rate of discharge (LRD) or a high rate of discharge (HRD).

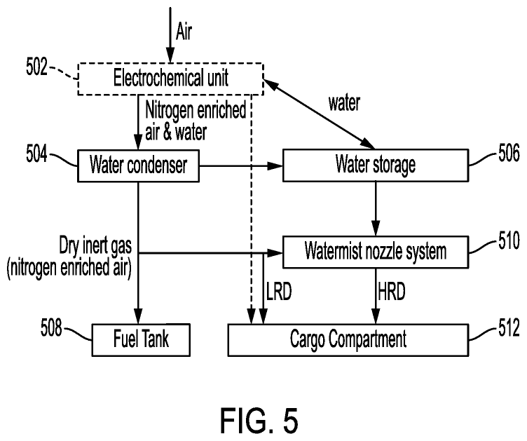

FIG. 5 is a process flow diagram of a method for fire suppression using a electrochemical fuel tank inerting system. FIG. 5 shows that air is provided to electrochemical unit 502. Electrochemical unit 502 produces nitrogen-enriched air for inerting gas and water. The inert products (e.g. nitrogen enriched air) are passed through water condenser 504, which removes the water from the inert products and store it in water storage/water source 506. The dry inert gas products are then provided to fuel tank 508. If required for fire suppression, dry inert gas or humid inert gas can be diverted to water mist nozzle system 510. Water storage/water source 506 provides water to dual fluid water mist nozzles system 510. Dual fluid water mist nozzles form a water mist from the inerting gas and the water and delivers the mist into cargo compartment 512 at either a low rate of discharge (LRD) or a high rate of discharge (HRD).

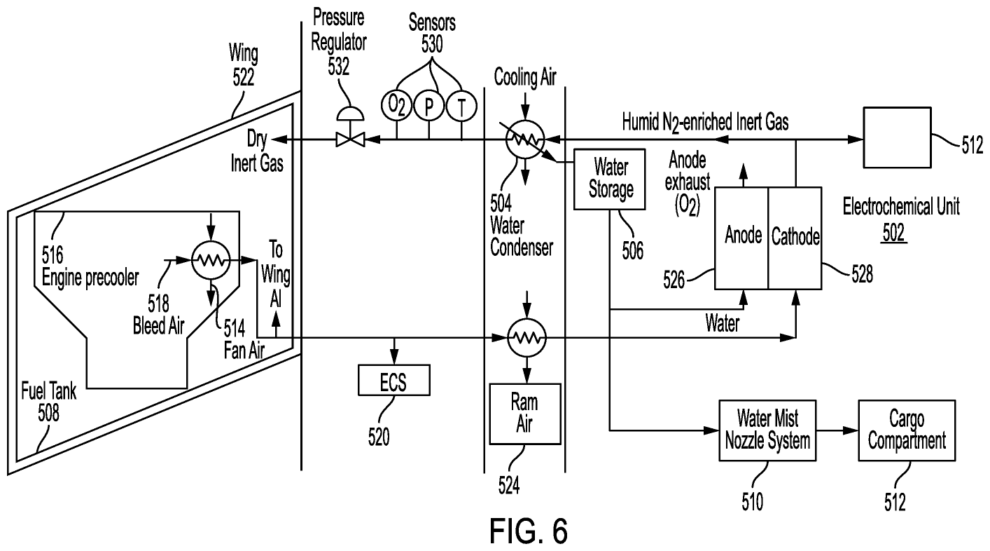

FIG. 6 is a detailed process flow diagram of a representative embodiment of the method of FIG. 5. FIG. 6 depicts electrochemical unit 502, water condenser 504, water storage/water source 506, fuel tank 508, water mist nozzle system 510, cargo compartment 512, fan air 514, engine precooler 516, bleed air 518, environmental control system (ECS) 520, wing 522, ram air 524, anode 526, cathode 528, sensors 530, and pressure regulator 532. Bleed air 518 from engine precooler 516 is provided to electrochemical unit 502. Engine precooler 516 also provides air for fan air 514, ECS 520, and ram air 524. Water is provided to electrochemical unit 502 from water storage/water source 506. Potential is applied between anode 526 and cathode 528, which produces humid nitrogen enriched inert gas. The inert products are passed through water condenser 504, which removes the water from the inert products and store it in water storage/water source 506. The dry inert gas products are then provided to fuel tank 508. If required for fire suppression, dry inert gas or humid inert gas can be diverted to water mist nozzle system 510. Water storage/water source 506 provides water to dual fluid water mist nozzles system 510. Dual fluid water mist nozzles form a water mist from the inerting gas and the water and delivers the mist into cargo compartment 512 at either a low rate of discharge (LRD) or a high rate of discharge (HRD). Humid or dry inert gas can also be delivered directly into cargo compartment 512 at a LRD or a HRD. Dry inerting gas is then passed through sensor 530 and pressure regulator 532 back into fuel tank 508 in wing 522.

### Discussion of Possible Embodiments

The following are non-exclusive descriptions of possible embodiments of the present invention.

A system for fire suppression, the system comprising: a fuel tank inerting system configured to produce an inert gas mixture; a water source; and a low pressure misting nozzle directed into a cargo hold; wherein the low pressure misting nozzle is configured to produce a mist solution using the inert gas mixture and water.

The system of the preceding paragraph can optionally include, additionally and/or alternatively, any one or more of the following features, configurations and/or additional components:

A further embodiment of any of the foregoing systems, wherein the fuel tank inerting system is a catalytic inerting system or an electrochemical inerting system.

A further embodiment of any of the foregoing systems, wherein the water source is condensation from the inerting system.

A further embodiment of any of the foregoing systems, wherein the fuel tank inerting system is an inerting membrane.

A further embodiment of any of the foregoing systems, wherein the water source is a primary aircraft water system.

A further embodiment of any of the foregoing systems, wherein the low pressure misting nozzle is configured to create a mist solution at a pressure of less than 2 atm.

A further embodiment of any of the foregoing systems, wherein the inert gas mixture comprises no greater than 16% oxygen.

A further embodiment of any of the foregoing systems, wherein the inert gas mixture comprises carbon dioxide, nitrogen, or a combination thereof.

A further embodiment of any of the foregoing systems, wherein the mist solution consists of water particles no larger than 1000 microns.

A further embodiment of any of the foregoing systems, wherein the mist solution has an average particle size of no greater than 100 microns.

A method of fire suppression, the method comprising: creating a mist solution including water and an inert gas mixture; flowing the mist solution into a cargo hold to suppress a fire; and flowing the inert gas mixture into the cargo hold after the fire is suppressed to maintain a low oxygen environment or target agent concentration.

The method of the preceding paragraph can optionally include, additionally and/or alternatively, any one or more of the following features, configurations and/or additional components:

A further embodiment of the foregoing method, further comprising the step of producing the inert gas mixture through a fuel tank inerting process.

A further embodiment of any of the foregoing methods, wherein the fuel tank inerting process is a catalytic inerting process or an electrochemical inerting process.

A further embodiment of any of the foregoing methods, wherein the water is a condensation product from the fuel tank inerting process.

A further embodiment of any of the foregoing methods, wherein the fuel tank inerting process is a membrane inerting process.

A further embodiment of any of the foregoing methods, wherein the mist solution is created using a low pressure effervescent system.

A further embodiment of any of the foregoing methods, wherein the mist solution is created at no greater than 2 atm.

A further embodiment of any of the foregoing methods, wherein the mist solution is flowed into the cargo hold at a rate of between 200 cubic feet per minute and 40 cubic feet per minute.

A further embodiment of any of the foregoing methods, wherein the inert gas mixture is flowing into the cargo hold at a rate of between 200 cubic feet per minute and 40 cubic feet per minute.

A further embodiment of any of the foregoing methods, wherein the low oxygen environment comprises no greater than 16% oxygen.

A further embodiment of any of the foregoing methods, further comprising flowing the inert gas mixture into the cargo hold containing to suppress the fire.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for fire suppression, the system comprising:
a fuel tank inerting system configured to produce an inert gas mixture;
a water source; and
a low pressure misting nozzle directed into a cargo hold;
wherein the low pressure misting nozzle being configured to produce a mist solution using the inert gas mixture and water.

2. The system of claim 1 wherein the water source is an onboard water tank, a condensation tank, or a combination thereof.

3. The system of claim 1 wherein the fuel tank inerting system is a catalytic inerting system or an electrochemical inerting system of an aircraft fuel tank.

4. The system of claim 3 wherein the water source is condensation from the inerting system.

5. The system of claim 1, wherein the fuel tank inerting system is an inerting membrane of an aircraft fuel tank.

6. The system of claim 1 wherein the low pressure misting nozzle is configured to create a mist at a pressure of less than 2 atm.

7. The system of claim 1 wherein the inert gas mixture comprises no greater than 16% oxygen.

8. The system of claim 1 wherein the inert gas mixture comprises carbon dioxide, nitrogen, or a combination thereof.

9. The system of claim 1 wherein the mist solution consists of water particles no larger than 1000 microns.

10. The system of claim 1 wherein the mist solution has an average particle size of no greater than 100 microns.

11. A method of fire suppression, the method comprising:
creating a mist solution including water and an inert gas mixture;
flowing the mist solution into a cargo hold containing to knock down a fire; and
flowing the inert gas mixture into the cargo hold after the fire is knocked down to maintain a low oxygen environment or target agent concentration.

12. The method of claim 11 further comprising the step of producing the inert gas mixture through a fuel tank inerting process.

13. The method of claim 12 wherein the fuel tank inerting process is a catalytic inerting process in an aircraft fuel system or an electrochemical inerting process in an aircraft fuel system.

14. The method of claim 13 wherein the water is a condensation product from the fuel tank inerting process.

15. The method of claim 12 wherein the fuel tank inerting process is a membrane inerting process in an aircraft fuel system.

16. The method of claim 11 wherein the mist solution is created using a low pressure effervescent system.

17. The method of claim 11 wherein the mist solution is created at no greater than 2 atm.

18. The method of claim 11 wherein the mist solution is flowed into the cargo hold at a rate of between 200 cubic feet per minute and 40 cubic feet per minute.

19. The method of claim 11 wherein the low oxygen environment comprises no greater than 16% oxygen.

20. The method of claim 11 further comprising flowing the inert gas mixture into the cargo hold containing to suppress the fire.
